(19) United States
(12) Patent Application Publication
(10) Pub. No.: US 2010/0256827 A1
(43) Pub. Date: Oct. 7, 2010

(54) Irrigation Controller Integrating Mandated No-Watering Days, Voluntary No-Watering Days, and an Empirically-Derived Evapotranspiration Local Characteristic Curve

(76) Inventors: Bruce Allen Bragg, Las Vegas, NV (US); Philip Andrew Kantor, Las Vegas, NV (US); Connie Ruby Masters, Henderson, NV (US)

Correspondence Address: CONNIE MASTERS, 2385 Flute Ave, Henderson, NV, 89052, US

(21) Appl. No.: 12/755,337

(22) Filed: Apr. 6, 2010

Related U.S. Application Data
(60) Provisional application No. 61/166,910, filed on Apr. 6, 2009.

(51) Int. Cl. G05D 7/06; G06F 15/18

(52) U.S. Cl. 700/284; 706/12

(57) ABSTRACT

A convenient, easy-to-use, water-saving, and labor-saving FROG smart irrigation controller is provided, which determines the appropriate water budget for the specific geographic region based on the preloaded ETo Local Characteristic Curve and preloaded mandated and voluntary watering restrictions for the specific geographic location, with consideration given to the reduction in watering days, the increase in soil watering depth, and the day of year. Once set, the FROG provides incremental adjustments over the course of the year; the homeowner no longer needs to re-set the watering program seasonally to comply with local mandated and voluntary watering restrictions. Compliance is automatic and obligatory, meeting the water saving goals of the local water authority.

### CROSS-REFERENCE TO RELATED APPLICATION

This Non-Provisional application claims the benefit of co-pending U.S. Provisional Patent Application Ser. No. 61/166,910, filed on Apr. 6, 2009.

### FIELD OF THE INVENTION

The present invention relates generally to an irrigation control system, and more particularly, to a controller or add-on controller using an empirically-derived evapotranspiration local characteristic curve and preloaded, local mandatory and voluntary no-watering restrictions.

### BACKGROUND INFORMATION

Irrigation controllers are commonly known in the prior art. They are electromechanical devices that control water delivery to a plurality of zones through the programmed opening and closing of water control valves, such as solenoid valves. For example, a residential landscape may be divided into eight separate watering zones. Some of the zones encompass turf requiring relatively more water delivered through sprayers. Some of the zones encompass bushes and trees requiring relatively less water delivered through bubblers and drip emitters. Homeowners or landscapers program the irrigation controller to deliver different amounts of water to these different zones by varying the amount of time the water control valves remain open in the course of a given irrigation cycle. For example, the valve covering Zone 1, a turf zone, may be programmed to be open five days per week (“watering days”), three times per day at specific times of the day (“start time”) for ten minutes (“run-time duration”); the valve covering Zone 2, a bush and tree zone, may be programmed to be open only three days per week, three times per day immediately following the cycles of Zone 1, but with run-time durations of only five minutes; and so on and so forth.

A limitation of such existing irrigation controllers is that they must be manually reprogrammed to respond to seasonal changes, as well as to watering restrictions mandated by local water authorities (“mandated watering restrictions”). Ten minutes of water, three times per day may be appropriate for a turf zone in summer, but excessive for winter. Moreover, in summer, the irrigation controller may be programmed to water on any day of the week, but in winter, mandated watering restrictions may limit “allowed watering days” to just one day per week, with six days a week mandated as “no watering days.” To effect the changes needed to adjust for the seasons and mandated watering restrictions, homeowners and landscapers must manually reprogram the controller.

Because the foregoing changes are few in number—typically four times per year corresponding to the four seasons—and because conventional irrigation controllers are relatively easy to reprogram, implementing the required seasonal changes and mandated watering restrictions should be an acceptable burden. However, even if homeowners and landscapers faithfully reprogram their irrigation controllers these four times per year, this would still result in a substantial amount of water waste. Moreover, local water authorities find that their water conservation programs are far less effective than they should be due to the failure of homeowners and landscapers to comply with mandated watering restrictions, because even the few and simple steps needed to comply with them are too difficult for many homeowners and landscapers, or they simply do not implement them.

The water waste inherent in four-times-per-year reprogramming of conventional irrigation controllers is caused by the fact that the water demand of plants changes far more frequently than just four times per year. The water demand of plants is dictated by the rate at which plants lose moisture to evaporation, and the rate at which they are capable of replacing it (“evapotranspiration”). Evapotranspiration is influenced by many factors, including temperature, humidity, soil moisture, sun exposure, wind and, of course, plant type.

Some factors, such as plant type and sun exposure, are taken into account through the regular programming of a conventional irrigation controller. For example, a homeowner knows he has trees and shrubs, not turf, in Zone 2 of his yard, and that this portion of the yard is shaded from the sun. He takes this into account by watering Zone 2 with bubblers and drip emitters, rather than the sprayers used on turf zones. He also takes it into account by programming his conventional irrigation controller with start times and run-time durations that make sense for this plant type and for shade conditions (as well as soil type and other factors).

However, the homeowner cannot take evapotranspiration factors into account in this way. For example, temperature, humidity and wind fluctuate constantly, changing the water demand of plants constantly—and far more often than four times per year. Reprogramming an irrigation controller four times per year takes into account a range of these fluctuations. For example, in summer, temperatures in the Las Vegas Valley typically range between 80° F. and 115° F., versus winter when they may range between 35° F. and 65° F. The fact is, however, that these ranges are very broad. In the course of a summer, temperatures (and/or other factors) may bias to the high end of the range or exceed it, in which case an irrigation controller programmed to deliver water in accordance with the average anticipated temperature in the middle of the range may result in plant loss, yet may deliver more water than is necessary at the beginning and end of the range.

With regard to mandated watering restrictions, some non-compliance is due to unwillingness of homeowners and landscapers to obey them. However, most non-compliance, according to local water authorities, is due to indifference or ignorance of the mandated watering days, despite local water authorities' best efforts to publicize them, or due to confusion over when and where they apply. For example, different sections of a local water authority's jurisdiction may be assigned a watering group, such as “A” or “B.” Homeowners in “A” may be assigned the allowed watering days Monday, Wednesday and Friday. Homeowners in “B” may be assigned the allowed watering days Tuesday, Thursday and Saturday. Thus, a homeowner must know whether he is in assigned watering group “A” or “B,” and must additionally know the allowed watering days for that watering group—all of which changes four times per year. As simple as this may seem, it is apparently too much for a substantial percentage of homeowners and, to the extent homeowners rely on them, landscapers.

Industry has responded to the foregoing problems by creating what are known as “smart controllers.” Following are examples of different approaches taken by smart controller developers.

One approach has been to make irrigation more scientific by benefiting from academic research on evapotranspiration. U.S. Pat. No. 5,208,855 issued to Marian discloses a smart controller outfitted with a receiver to pick up evapotranspiration data broadcast by weather stations and agricultural extensions. Such broadcasts consist of daily information for various localities about environmental factors such as temperature, humidity and wind. These data have been processed to determine their effect on evapotranspiration and, thus, water need for a reference crop, namely, turf (determining what is known as reference evapotranspiration or “ETo”). Upon setting up the Marian smart controller, the user inputs his zip code and information about the type of plants he is irrigating, so that the smart controller may automatically pick up the broadcast ETo information applicable to the user's locality, and calculate the water need of the user's plant matter as a percentage of ETo (based upon crop coefficients, which are published analyses of the evapotranspiration water needs of plant types as a percentage of the evapotranspiration water needs of turf). Unfortunately, Marian's smart controller has numerous drawbacks for the average homeowner: (1) its emphasis on crop coefficients is suited to agriculture, not average homeowners, (2) the need for a receiver and relatively complicated data entry screen contribute to cost and complexity, and (3) broadcast malfunctions can disrupt irrigation. In the case of agriculture, these drawbacks are less important, because farmers are willing to, and do devote great attention to irrigation systems. Average homeowners do not, and a disruption to irrigation, for example, could subsist for days before a homeowner even noticed it.

U.S. Pat. No. 6,453,216 issued to McCabe et al. and U.S. Pat. No. 6,892,113 issued to Addink et al. disclose devices using historical evapotranspiration data as the means to determine a watering budget (McCabe et al.) or as part of the means to do so (Addink et al.). For example, historical evapotranspiration data may consist of an average of the evapotranspiration data for the same date over a multiyear period, e.g., December 1, for a specific location, e.g., Amarillo, Tex., for the three years 2000, 2001 and 2002. The advantage of using historical evapotranspiration data is that they free the user from needing to obtain current data, for example, by broadcast transmission, and entering current data into the smart controller. Instead, the historical data can be preloaded into the smart controller, enabling the smart controller to deliver water in accordance with the average historical evapotranspiration for that date and location. U.S. Pat. No. 6,314,340 issued to Mecham et al. discloses a device that measures high and low temperatures for the day, and then uses a specific formula, namely, the Hargreaves formula, to determine an appropriate watering budget. However, none of these patents address the problems of lack of compliance with mandated watering restrictions or with the troublesome requirement for the homeowner to reset the irrigation schedule of his irrigation controller each season to meet seasonal watering needs and/or seasonal mandated watering restrictions.

Another approach has been to create smart controllers capable of tracking one or more of the environmental factors affecting evapotranspiration rate, and increasing or decreasing water output in accordance with them. For example, U.S. Pat. No. 4,684,920 issued to Reiter and U.S. Pat. No. 4,922,433 issued to Mark focus on soil moisture. Using sensors placed in the ground throughout the area to be irrigated, these smart controllers benefit from real-time soil moisture readings in order to provide the right amount of irrigation. However, while these devices may be suitable for agricultural or commercial use (e.g., golf courses and shopping centers), they are not suitable for average homeowners, because the deployment and maintenance of soil sensors require too much effort and expense relative to homeowners' modest landscaping needs.

U.S. Pat. No. 5,839,660 issued to Morgenstern et al. focuses primarily on precipitation and wind, disclosing a smart controller that measures these environmental factors and cuts off irrigation if either one exceeds a set value. However, among other disadvantages, this smart controller cuts off, rather than modifies a conventional irrigation program in response to high precipitation and wind values, which is less than optimal.

U.S. Pat. No. 6,892,114 issued to Addink et al., and U.S. Pat. No. 7,165,730 issued to Clark disclose smart controllers capable of measuring one or more environmental factors for the purpose of modifying the irrigation schedule of a conventional controller. However, both devices disclose suboptimal design, since they are not in series between an existing controller and the irrigation valves, but communicate only with the existing controller to modify an irrigation cycle, as discussed in greater detail below. U.S. Pat. No. 7,266,428 issued to Alexanian focuses solely on temperature as the predominant environmental factor affecting evaporation rate, and uses a non-standard evapotranspiration formula based solely on temperature to create water budgets.

Yet another approach has been to provide smart controllers giving users greater control over their irrigation systems. For example, U.S. Pat. No. 7,010,396 issued to Ware et al. covers an irrigation controller with an embedded Web server enabling the user to interact remotely and, hence, more frequently and conveniently with the controller. However, for the average homeowner, what is needed is not more involvement with the irrigation controller, but greater irrigation efficiency without more involvement.

Further, when adjusting the watering run-time duration or cutting off the irrigation, smart controllers of the prior art do not take into consideration the number of mandated no-watering days blocked out and the additional increased reduction in water delivery. For instance, in some regions in winter, there is only one allowed watering day per week, with six days of the seven mandated as no-watering days. If the irrigation is cut off on the one allowed watering day (such as due to an environmental factor), no irrigation will be given for two weeks. Similarly, as described in U.S. Patent Publication No. 2010/0030476 by Woytowitz et al., on the one allowed watering day, the watering run-time duration may be reduced by a relatively large percentage based on environmental factors through a seasonal adjust feature based on historical evapotranspiration rates, without accounting for the additional reduction forced by the six mandated no-watering days.

Unfortunately, no prior art device has effectively solved the problem of making irrigation efficiency more affordable and less burdensome for the average homeowner, while providing a simple means to implement local mandated watering restrictions, and thus promote the water-saving goals of the local water authority by increasing compliance. Smart controllers' complexity and expense, as well as their suboptimal design and methodology, have prevented them from penetrating this market that is crucial not only from a profit standpoint, but from a water and energy conservation standpoint. (For example, pumping water to the Las Vegas Valley is the region's single greatest use of energy.)

### SUMMARY OF THE INVENTION

The present invention, referred to here as the FROG smart controller, is directed to an easy-to-use, labor-saving irrigation controller that controls the start time and run-time duration of the irrigation valves based on a FROG watering schedule using a novel integration of the preloaded mandated watering restrictions (from a local water authority) and the preloaded “ETo Local Characteristic Curve” (for example, an ETo Local Characteristic Curve has been published for the Las Vegas Valley), setting forth the water need of the locally predominant variety of landscape material at different times of the year for the particular location, based upon empirical research, plus a novel algorithm based on total water volume. The value of the ETo Local Characteristic Curve for a particular day is herein referred to as “ET_{local}.” The FROG of the present invention is configured to serve only a few geographic locations at a time and, preferably, just one, such as the Las Vegas Valley.

Four embodiments that use the novel integration and/or novel algorithm of the current invention are presented. In the first preferred embodiment (FIG. 1) the FROG is a simple add-on device in series between a conventional irrigation controller (the “existing controller”) and irrigation valves.

In the second embodiment (FIG. 2) the FROG is a comprehensive controller, allowing setting of the start times and run-time durations for the multiple zones, as well as operating the irrigation valves, negating the need for a conventional controller.

In the third embodiment (FIG. 3, FIG. 4), a sensor module connectable to the FROG and in communication with a freestanding remote weather station is supplied. The remote weather station includes one or more environmental sensors (such as temperature, humidity, solar radiation, rainfall, etc.) The novel algorithm is modified by the one or more received current environmental values, preferably after an environmental-factor averaging calculation is performed.

In the fourth embodiment (FIG. 5 to FIG. 7), a supplementary user input system is provided, which may be utilized with any of the other presented embodiments. Additionally, when the supplemental user input system is provided, the local geographic location is user-selectable; therefore, the FROG may be preloaded with data for numerous geographic locations. A variety of types of supplemental user input systems are presented.

The FROG automatically “learns” the programmed watering schedule (“initial watering schedule”) including the start times (“initial start times”) and run-time durations (“initial run-time durations”) of the existing controller in a “learn mode.” Two learn modes are presented. After completion of the learn mode, the FROG takes over the scheduling of irrigation and operation of the irrigation valves, implementing the FROG watering schedule. The FROG modifies programmed run-time durations based upon the pre-programmed mandated watering restrictions (for the location or locations it serves) and a standard ETo formula, such as Penman-Monteith, which has been modified to account for the differential factor comprising the difference between the standard ETo formula and the ETo Local Characteristic Curve for the location.

Upon installation, after specifying his geographic location (for embodiments offering more than one geographic location), the user enters his assigned watering group, such as “A” or “B.” If start times of the existing controller conflict with assigned watering days, the FROG will prevent watering on those days, with adjustments made in the FROG watering schedule for these blocked watering days.

In another aspect, the FROG smart controller is also designed with a user-donated (and preferably user-selectable) “float” day, a “voluntary no-watering day”. In exchange for a credit applied to the homeowner's water bill, the homeowner may designate one additional day as a voluntary no-watering day. Thus the water saving goals of the water authority are furthered.

An object of the present invention is to provide a FROG smart controller that implements mandatory watering restrictions, thus insuring compliance and saving water.

A further object of the present invention is to provide a FROG smart controller that is easy to operate and convenient for the user (homeowner, business owner, or landscaper).

An additional object of the present invention is to provide a FROG smart controller that provides incremental adjustments of the water budget, as opposed to merely seasonal adjustments.

Another object of the present invention is to provide a FROG smart controller that delivers the appropriate amount of water to meet the need of the locally predominant variety of landscape material at different times of the year for the particular geographic location.

These and other objects, features, and advantages of the present invention will become more readily apparent from the attached drawings and from the detailed description of the preferred embodiments, which follow.

### BRIEF DESCRIPTION OF THE DRAWINGS

The preferred embodiments of the invention will hereinafter be described in conjunction with the appended drawings, provided to illustrate and not to limit the invention, where like designations denote like elements, and in which:

FIG. 1A depicts a front view of the FROG add-on controller of the first preferred embodiment of the present invention having a graphic display and being connected to an existing conventional irrigation controller;

FIG. 1B depicts a front view of the FROG add-on controller of the first embodiment of the present invention having a simplified user-interface and being connected to an existing conventional irrigation controller;

FIG. 2 depicts a front view of the FROG comprehensive controller of the second embodiment of the present invention;

FIG. 3 depicts a front view of a sensor module attached to the FROG add-on controller of the third embodiment of the present invention, wherein the FROG add-on controller is in communication with a weather station housing one or more environmental sensors and is connected to an existing conventional irrigation controller;

FIG. 4 depicts a front view of a sensor module attached to the FROG comprehensive controller of the fourth embodiment of the present invention, wherein the FROG comprehensive controller is in communication with a weather station housing one or more environmental sensors;

FIG. 5A depicts a side view of the FROG controller of the fourth embodiment of the present invention configured with a supplementary user input system including a reader slot and optical reader;

FIG. 5B depicts a top view of the FROG controller of the fourth embodiment of the present invention configured with a supplementary user input system including a reader slot and optical reader;

FIG. 5C depicts a front view of an insertable sheet imprinted with a QR Code®-type optical code (such as could be printed on a customer's bill) for inserting into the reader slot of the supplementary user input system;

FIG. 5C depicts a detail of the circle of FIG. 5C showing the QR Code®-type optical code readable by the optical reader;

FIG. 6A depicts a side view of the FROG controller of the fourth embodiment of the present invention configured with a supplementary user input system including a slide slot and a magnetic strip reader;

FIG. 6B depicts a top view of the FROG controller of the fourth embodiment of the present invention configured with a supplementary user input system including a slide slot and a magnetic strip reader;

FIG. 6C depicts a front view of a card carrying a data-impregnated magnetic strip configured to slide through the slide slot to allow reading by the magnetic strip reader;

FIG. 7A depicts a side view of the FROG controller of the fourth embodiment of the present invention configured with a supplementary user input system including a controller electronic connection;

FIG. 7B depicts a top view of the FROG controller of the fourth embodiment of the present invention configured with a supplementary user input system including a controller electronic connection;

FIG. 7C depicts a front view of a data storage unit, such as a USB flash drive or the like, configured with a complementary drive electronic connection;

FIG. 8 depicts a schematic of the add-on FROG smart controller of the first embodiment. The installed existing controller 20 is wired zone-by-zone through bridge cable 12 to the main control unit of the FROG 10;

FIG. 9 depicts a schematic of the remote weather station 40 of the third embodiment;

FIG. 10 depicts the reference evapotranspiration curve (from which ET_{local} for each time point is derived) of the type used by the FROG smart controller to determine the correct watering needs of landscape material in a given geographic location, such as the Las Vegas Valley, for a given time of year;

FIG. 11 depicts a schematic of the variables of the novel algorithm; and

FIG. 12 depicts a flowchart of the learning mode method.

Like reference numerals refer to like parts throughout the several views of the drawings.

### DETAILED DESCRIPTION OF THE PREFERRED EMBODIMENTS

Shown throughout the figures, the present invention is directed toward a FROG 10 smart controller that improves the efficiency of irrigation scheduling and saves water through use of a novel integration of preloaded empirically-derived evapotranspiration local characteristic curve (from which the ET_{local} for the watering day is obtained) and the preloaded local mandated watering restrictions. Consequently, the FROG 10 provides advantages for both the homeowner (convenience, labor reduction, improved water delivery correlated to day of year) and the local water authority (obligatory compliance with mandated watering restrictions). An important strategy in reaching the water saving goals of the local water authority is met through the hard-to-achieve increased compliance resulting from use of the FROG 10 irrigation control system.

The FROG 10 is targeted toward only a few geographical locations at a time, and, preferably, just one, such as the Las Vegas Valley. It may be pre-programmed for only the one designated geographic location in which it will be sold, with only the ET_{local} and mandated watering restrictions (such as no-watering days and/or no-watering hours of the day and/or the watering days corresponding to each assigned watering group and the like) of that designated geographic location preloaded. (The term “preloaded” refers to an initial loading of the information into the FROG 10 irrigation controller, either by the manufacturer, distributor or intermediary, or by the installer or homeowner [such as by the supplementary user input system 70] before initial use.]) If only preloaded with one designated geographic location, the designated geographic location is not selectable by the user and complexity is reduced. Optionally, it may be preloaded with the ET_{local} and mandated watering restrictions of many geographic locations, with the geographic location to be designated by the user (such as by the use of the basic input devices or supplementary user input system 70).

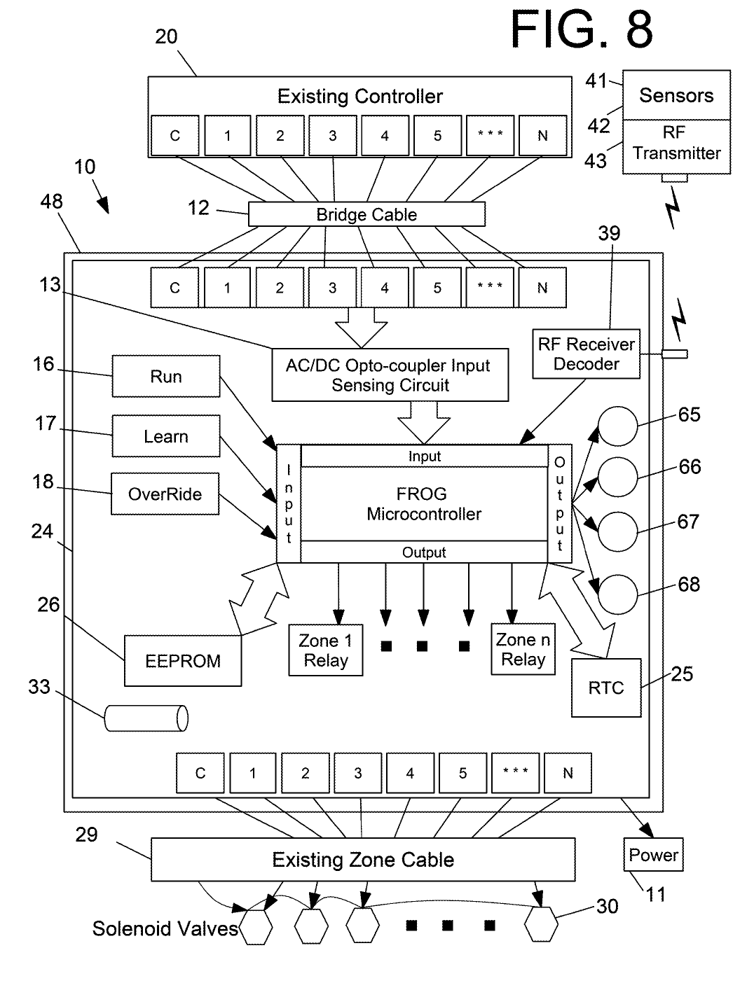

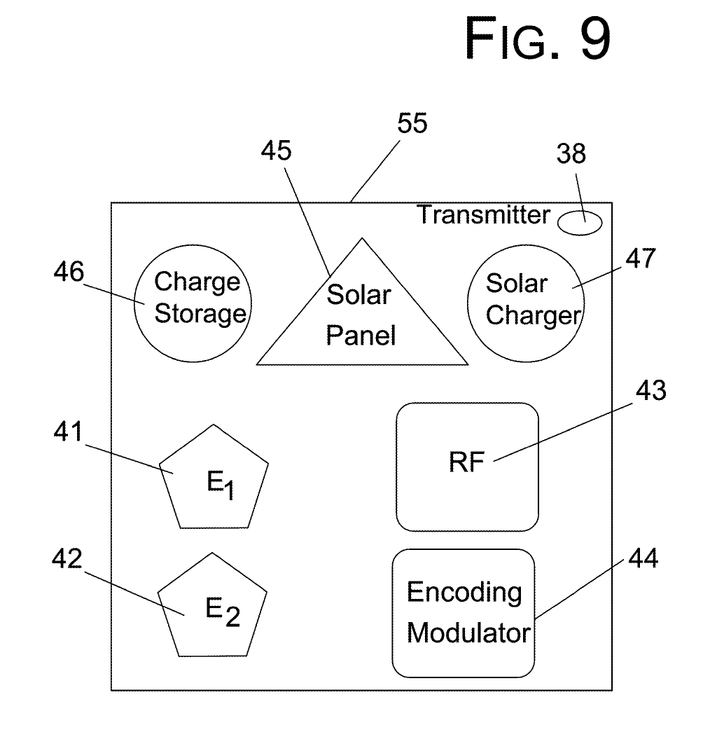

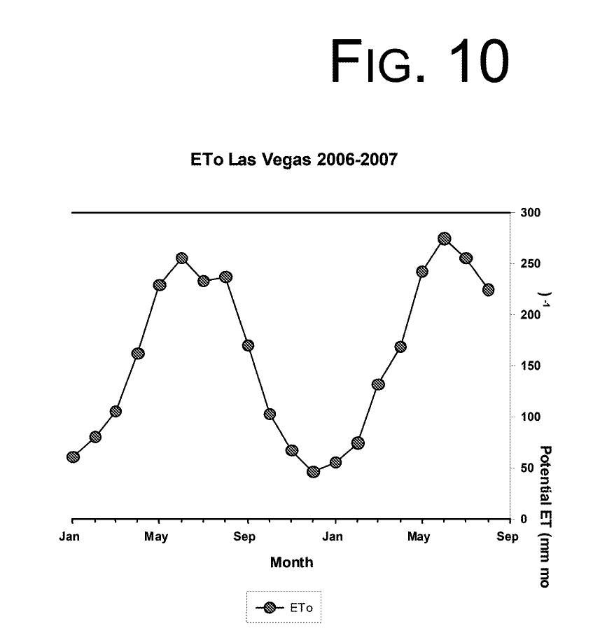

As opposed to the conventional automatic controllers for in-ground irrigation systems that the homeowner must reset four times a year to meet the seasonal watering need changes and the seasonal changes in local water authority mandated watering restrictions, the homeowner initially sets the FROG 10 and then forgets it, with no further effort required (except the suggested periodic replacement of the back-up battery 33, FIG. 8).

Additionally, as opposed to conventional controllers that generally water for an entire season based on a single setting, the FROG 10 provides an incremental adjustment based on the actual day of the year or on a few days surrounding the watering day by using the ETo Local Characteristic Curve for the location. A conventional controller set in April for an April to June season will deliver more water than is needed in April and/or less water than is needed in June. The FROG 10, once initially set, will deliver water corresponding to the local watering needs incrementally adjusted in correlation with the watering day.

Also, in contrast to conventional controllers, consideration is given to the number of mandated no-watering days by the novel integration and/or novel algorithm, so the plants receive adequate water even when the number of allowed watering days is greatly reduced. The novel algorithm additionally incorporates a compensation coefficient S and a watering depth factor W to further refine the total volume of water delivered (the water volume is not a flow meter-measured volume, but is a quantity related to the flow rate, run-time duration, number of start times, number of days watered).

The novel integration and/or novel algorithm may be advantageously used with a number of types and configurations of irrigation control systems. Four exemplary embodiments (with additional aspects and variations) utilizing the novel integration and/or novel algorithm are demonstrated to illustrate the general usability of the novel integration and algorithm with these and other configurations.

The first embodiment of FIG. 1A, FIG. 1B presents the FROG embodied as an add-on controller for connection to an existing conventional irrigation controller 20. FIG. 1 includes a graphic display, while an economical, simplified user interface is presented in FIG. 1B. “Learn mode” methods are presented, allowing the add-on FROG 10 to learn the start times and run-time durations for the various zones of the existing controller 20

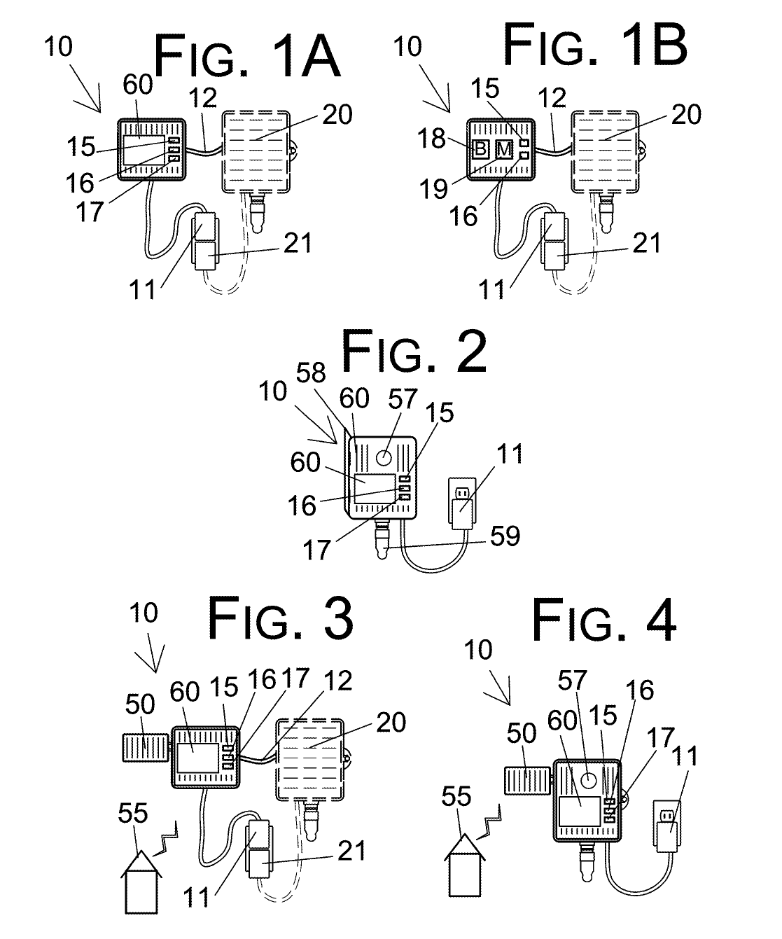

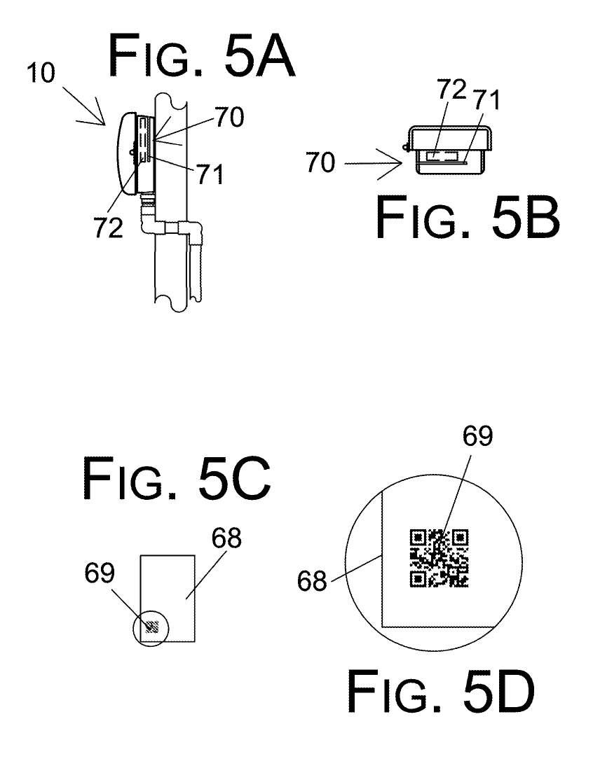

The second embodiment of FIG. 2 presents the FROG as a “comprehensive controller” applying the novel integration and/or novel algorithm to the watering schedule as in the first embodiment, but additionally configured to allow a user to manually program start times and run-time durations for the various zones, thereby removing the need for the conventional controller 20.

The third embodiment of FIG. 3, FIG. 4, and FIG. 9 presents a sensor module connectable to either the add-on or the comprehensive FROG; the sensor module 60 is in communication with a provided remote weather station 55 housing one or more environmental sensors 41, 42.

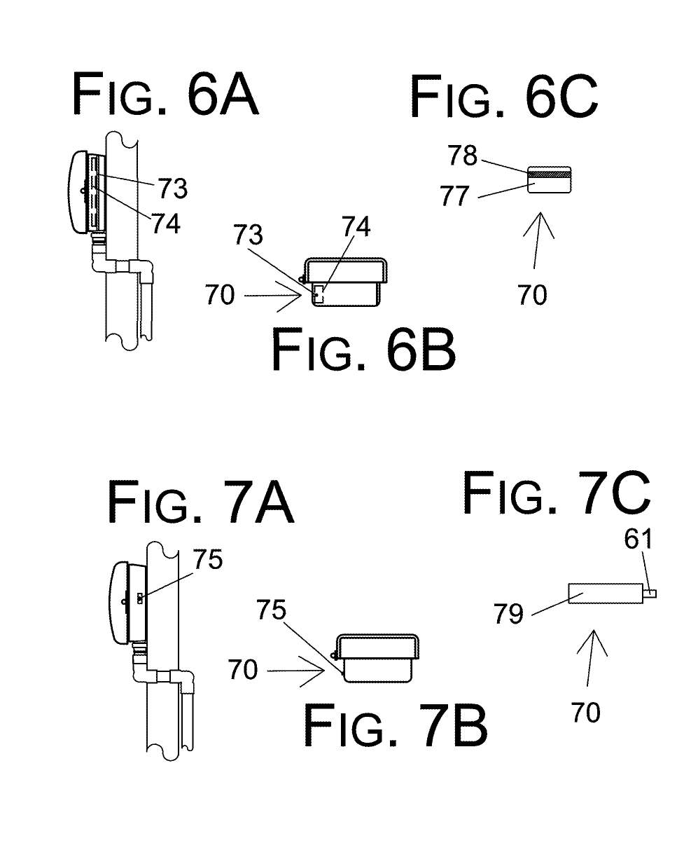

The fourth embodiment (FIG. 5A, FIG. 5B, FIG. 5C, FIG. 5D, FIG. 6A, FIG. 6B, FIG. 6C, FIG. 7A, FIG. 7B, and FIG. 7C) presents an optional supplementary user input system 70 for use with either the add-on or comprehensive FROG; variations of the supplementary user input system are also presented.

Referring now to the first embodiment of FIG. 1, add-on FROG 10 is designed to work with an installed existing controller 20 that has been programmed to take into account the appropriate watering needs of the plant types predominating in each individual irrigation zone of the user's landscape. For example, a zone comprising predominately turf may deploy sprayers scheduled to run on several days at several times per day for relatively long run-time durations; a zone comprising predominately trees and shrubs may deploy bubblers and drip emitters scheduled to run on fewer days at fewer times per day for relatively short run-time durations. Further, zones that are relatively shaded may be scheduled for start times and run-time durations reflecting a different and lower watering need due to the shaded conditions.

The add-on FROG 10 is in communication with existing irrigation controller 20, connected to the existing controller 20 by bridge cable 12. The existing controller 20 may optimally be programmed to provide the full amount of water needed for each zone under the hottest and driest anticipated conditions of the year. This is because the FROG will cut back water output as determined by the novel integration and/or novel algorithm based on ET_{local} and mandated watering restrictions, but does not boost water output beyond what has been programmed into the existing controller 20.

As shown in FIG. 8, the main control unit 24 of the FROG 10 (the “main control unit”) is enclosed in housing 48 and is wired to the existing controller 20, with the FROG 10 preferably in physical proximity to the existing controller 20 to minimize the amount of bridge cable 12 required. Housing 48 may be designed for indoor use or may comprise an all-weather enclosure to enable close physical proximity to the existing controller 20, even if the existing controller 20 is in an exterior location.

The main control unit 24 comprises several groups of features, including: (1) an existing-controller input system configured to allow main control unit 24 to communicate with , such as an input terminal strip 13, connecting to the AC/DC opto-coupler input sensing circuits 14, connecting in turn to a microcontroller 22; (2) at least one non-volatile memory, EEPROM (Electronically Erasable Programmable Read-Only Memory) 26 and real-time clock 25; (3) microcontroller 22 and associated circuitry; and (4) a microcontroller water-valve regulation system configured to allow the microcontroller to control the water control valves 30, such as by connecting the microcontroller outputs to a zone relay bank 27, connecting to the output terminal strip 28, which is in turn wired to existing zone cable 29 regulating water control valves 30.

Before undertaking to wire the main control unit 24 to the existing controller 20, the user preferably marks or makes note of the existing controller's zone cable 29 wiring scheme, e.g., red wire connects Zone 2; black wire connects Common (C); etc. The cable is then removed. The bridge cable 12 of the main control unit 24 is then connected to the existing controller 20, as annotated, which is to say that Zone 1 of the main control unit is connected to Zone 1 of the existing controller 20; the Common of the main control unit is connected to the Common of the existing controller 20; etc. To the extent the main control unit 24 has more available zone wires than the existing controller 20 has active zones, such extra zone wires are ignored and may be terminated.

Next, the main control unit 24 is connected to the irrigation valves 30 by reconnecting the existing controller's zone cable 29 to the main control unit zone output terminals 28, taking care to correlate the zone and Common designations marked or noted during the removal process as explained above.

In an aspect, the main control unit 24 has its own power supply 11 (FIG. 1, FIG. 8, which may include a plug-in transformer), and is separately plugged into an electrical outlet. By not drawing power from the existing controller 20 as provided in prior art devices, the FROG does not risk causing the existing controller 20 to exceed its power supply power rating.

The FROG's processing power may be supplied by a conventional microcontroller or microprocessor (the “microcontroller”) 22 (such as a RISC-based microcontroller based on the Harvard architecture or other microcontroller means currently available or as may be developed in the future) in conjunction with a real-time clock (the “RTC”) 25 and at least one non-volatile memory for storing static data (such as EEPROM 26, RAM, or other memory storage means currently available or as may be developed in the future). The microcontroller 22 may be preprogrammed with a supervisory program that manages all components, circuits, program logic, inputs, outputs, and control (the “microcontroller program”). The microcontroller program is responsible for monitoring, managing and controlling the overall operation of the FROG.

The main control unit 24 may be outfitted with one or more basic input devices 15, 16, 17, 18, 19 such as a rotary switch, push button, or digital control, which may be indicated by a light, LED 20, or other means, audible and/or visual. A basic input device 15, 16, 17, 18, 19 can be used to input data or initiate events, digitally or mechanically. One or more of the more basic input devices can be used to input data or to make selections and interface with the graphic display screen. For example, to input the applicable watering group as assigned by the local water authority, to adjust the float day, to initiate “learn mode,” or to initiate “run mode.” Once the input is received, it may be stored in the EEPROM 26.

In one aspect, illustrated in FIG. 1B, a simple controller without a graphic display is presented. Four basic input devices are illustrated, a “learn mode” input 15, a “run mode” input 16, a mandated watering group (as assigned by the local water authority) designation input 18, and a float day input 19.

In another aspect, illustrated in FIG. 1A, the FROG 10 is configured with a graphic display 60 viewable to the user and operable to display useful information, such as displaying requests for specific user input, values input by the user, and error messages.

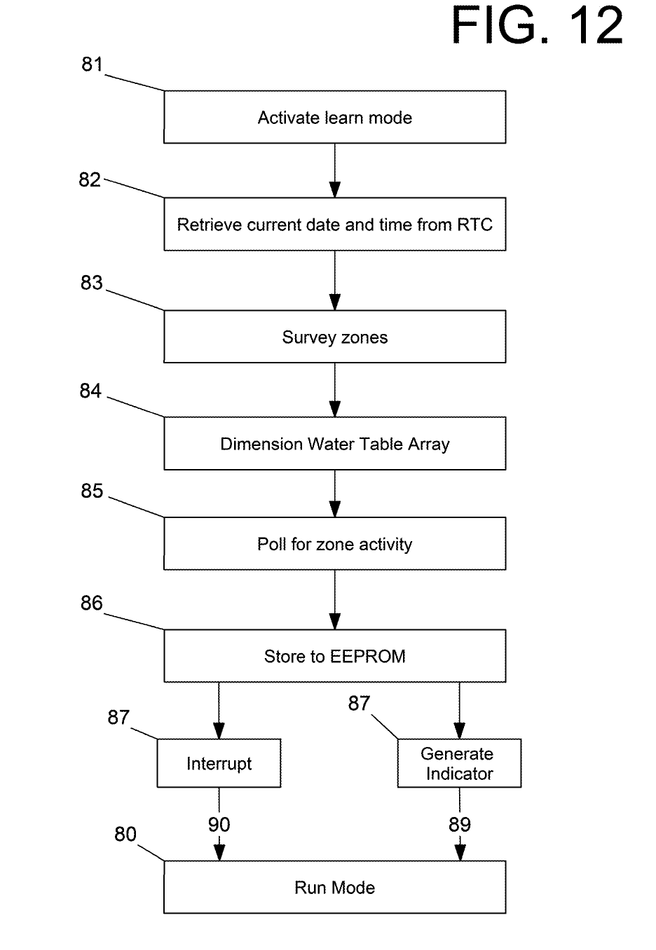

As shown in the flowchart of FIG. 12, to continue setup of the FROG, the user activates 81 the device to “learn mode.” This may be accomplished by engaging “learn mode” input 15. Once learn mode is initiated, the microcontroller program retrieves 82 the current date and time from the RTC 25. The microcontroller program then surveys 83 the number of zones wired to the existing controller 20 by sensing the presence of polarized voltage levels via the AC/DC opto-couplers input sensing circuits 14. Using this information, the microcontroller program dimensions 84 the watering table array. Once completed, the microcontroller program polls 85 for zone activity equating to start times and run-time durations. It accomplishes this, for example, by using an AC/DC opto-coupler input sensing circuit 14 to sense zone activity through DC voltage level transitions and/or alternating voltage level transitions at a standard frequency, such as 50 Hz, 60 Hz, 120 Hz, etc. In this first learn mode method, the learn mode extends over a default period of two weeks. Those skilled in the art will know that other default periods may be used, however, two weeks corresponds to the most typical default period in that homeowners using “skip-day” programs run through their entire irrigation cycle over a two-week period. The data collected in learn mode may be stored 86 in EEPROM 26.

Depending upon the default period programmed into the microcontroller or EEPROM 26, the RTC 25, may generate an interrupt 87 that is passed to the microcontroller 22, which is interpreted by the microcontroller program as a termination of learn mode. Alternatively, the microcontroller program may store the ending date and time as an ending sentinel for a matched value-type termination routine. At this time, the microcontroller program generates 88 a visual or audible indication, such as a flashing LED 66, that learn mode is complete. Reacting to this, the user may activate 89 “run mode,” such as by pressing a “run mode” input button 16, or the microcontroller program may be programmed to automatically initiate 90 run mode 80, which effectively transfers watering schedule control to the FROG.

Another aspect of the invention, in which the learn mode may be a four-week process, is presented to accommodate the installation of the FROG 10 at times of the year other than during the summer (when the summer maximum water volume would be appropriate). For example, if the FROG 10 is to be installed in mid-winter when the water requirement for the landscape is minimal, a great deal of water is wasted if the summer maximum schedule is applied daily for two weeks in order to allow the FROG 10 to learn the summer maximum schedule.

During the first two weeks of the four-week learn mode, the existing controller 20 is not adjusted to the summer maximum watering schedule, but continues on its existing, preset schedule. The FROG 10, in a learning-override mode, learns this starting-point existing schedule during the course of the first two weeks, but does not control the water control valves. At the end of the first two weeks, the existing controller 20 is reset to the summer maximum water start times and run-time durations for all of the zones. At the end of the first two weeks, an audio or visual reminder may be produced by the FROG 10, or in addition or instead, an outside reminder input (such as a reminder letter, email, text or phone call from the water authority) may remind the homeowner of the need to reset the existing controller 20 to the summer maximum watering schedule.

Though the FROG 10 learns the start times of the summer maximum watering schedule and may be programmed to duplicate them, optionally the FROG 10 may be programmed to automatically shift the start times toward the middle of the day during colder months. Generally the summer watering hours may be restricted by the water authority to the morning hours, such as before 10 a.m., to minimize evaporation. Start times forced into the early morning may not be optimum for colder months. The FROG 10 can be preprogrammed with any mandated no-watering hours, as well as mandated no-watering days. The preprogramming (or optionally, the supplementary user input system 70) can give consideration to the mandated no-watering hours and to the climate of the local geographic area and adjust the start times, as needed.

In the second two-week period of the four-week learn mode, the FROG 10, in a learning-controlling mode, enforces the starting-point existing schedule by controlling the water control valves 30, as learned during the first two-week period. Additionally, over the second two week period the FROG 10 learns the newly set summer maximum watering schedule and stores this summer maximum watering schedule in EEPROM 26. Thus the landscape receives the same amount of water in the second two-week period (as controlled by the FROG 10) as it received during the first two-week period. In this way, without overwatering by using the summer maximum watering schedule during the fall, spring or winter, the FROG 10 can learn and store the summer maximum watering schedule for use in the novel integration and/or novel algorithm. At the end of the four-week learn mode, run mode is activated in the FROG 10, as described above (either by manual input 89 (FIG. 12) of the user or, more preferably, by automatic initiation 90 by the microcontroller program).

Once in run mode, the microcontroller program first determines the day of the week by accessing the RTC 25. If it is a no-watering day based upon preloaded mandated or voluntary watering restrictions and the user-selected watering group, then the FROG does not activate any water control valves 30 throughout that day.

If it is not a no-watering day, the microcontroller program next determines the current date by accessing the RTC 25, enabling it to determine the current season of the year. Using this information, the microcontroller program applies the novel integration and/or novel algorithm to determine a FROG watering schedule for the next irrigation cycle, a numeric value comprising the optimal watering budget for the next irrigation cycle, such as a percentage multiplier and/or an application of a compensation coefficient of the existing controller's initial run-time duration.

The determination of this FROG watering schedule is made by using the value of ET_{local} corresponding to the ET value of the particular day (or an average of a set of values corresponding to nearby days) from the ETo Local Characteristic Curve table of values for the designated geographic location (such as depicted in FIG. 10). This final FROG watering schedule numeric value, comprising a modified and/or compensated run-time duration, may be stored in EEPROM 26. The microcontroller program then activates the relay 27 that, in turn, activates the applicable water control valve 30.

This is in contrast to prior art smart controllers that do not themselves control water control valves but actively monitor the existing controller outputs and interrupt the controller, typically over the Common wire, to modify irrigation run-time durations. The prior art arrangement effectively doubles the risk of unreliability because, while the FROG only risks disrupting irrigation if it malfunctions itself, prior art smart controllers risk disrupting irrigation if either they malfunction themselves or the existing controller malfunctions itself.

Also, as opposed to the smart irrigation controllers of the prior art, the FROG 10 enforces mandatory watering restrictions, provides incremental water adjustments, and bases the watering budget on the total water volume at the summer peak watering settings of the existing controller 20 delivered over a time period (such as a week or since the last watering day), taking into consideration the number of no-watering days and calculating compensation coefficients along with delivery frequency adjustments.

Prior art smart controllers are merely programmed to reduce this daily watering volume by applying an evapotranspiration rate (or by one of a variety of means), without considering the additional reduction that will occur as days are removed by mandated watering restrictions. For example, the summer maximum watering schedule is applied every day for seven days in the summer when all days are watering days. Prior art smart controllers learn the daily summer maximum watering volume. Then, in mid-winter, these controllers reference the applicable evapotranspiration rate to cut back the daily summer maximum watering volume, appropriately resulting in a significant reduction in water to be delivered on a daily basis (a “winter reduced daily volume”). However, prior art smart controllers do not take into account the large number of no-watering days that may be mandated by local water authorities. Consequently, the “winter reduced daily volume” is, in fact, not applied daily, resulting in an over-reduction in water delivery. For instance, in the Las Vegas Valley, only one watering day is allowed in winter—consequently six days are no-watering days. If this is not taken into consideration, the water delivered to the homeowner's property is a mere fraction of the needed amount determined by landscaping needs: only one of the winter reduced daily volume amounts is delivered on the one available day.

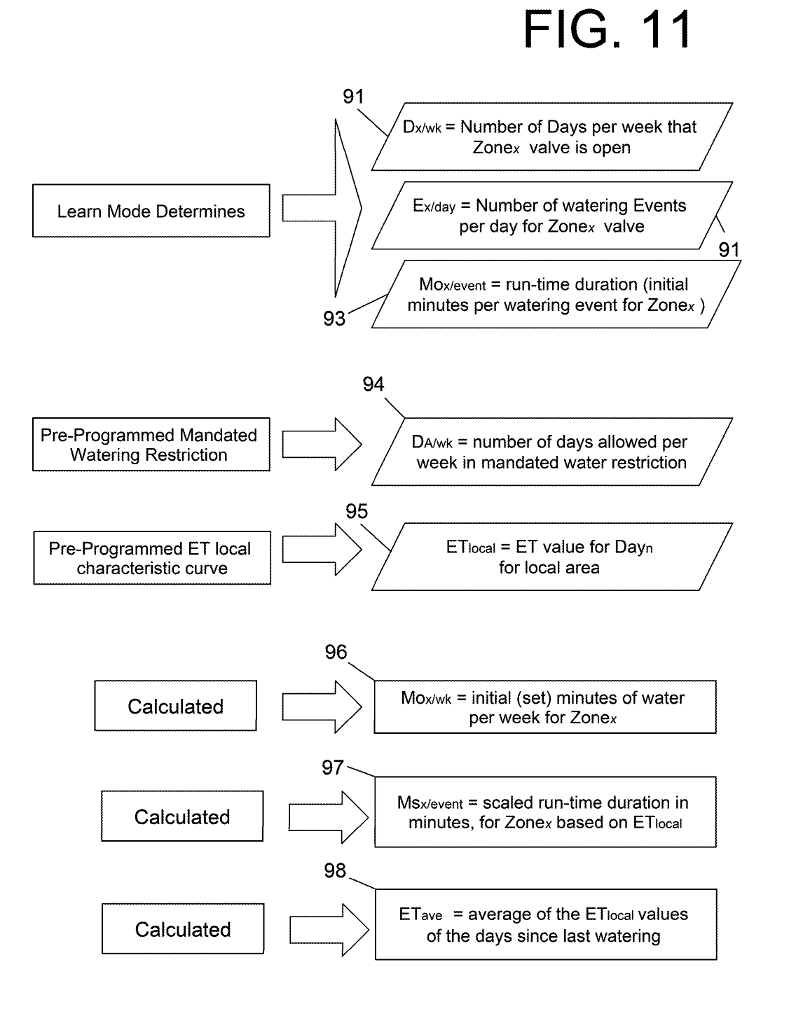

In one aspect of the novel algorithm microcontroller program of the FROG 10 may calculate the initial total volume of water delivered by the existing controller during a particular time period (a particular number of days near the day of watering, such as the week before watering, as used in the below example, Mo_{x/wk}, FIG. 11). This total volume (Mo_{x/wk}) is proportionally distributed (with other factors taken into account) to the number of allowed watering days near the day of watering. This total volume of water (Mo_{x/wk}) may be used in the determination of the scaled watering minutes for each watering event for each zone (Ms_{x/event}, FIG. 11). The novel algorithm may also be used by the FROG 10 to assist in calculating the FROG watering schedule, a schedule based on the initial watering schedule of the existing controller 20 but modified by the novel integration of mandated watering restrictions and the empirically-derived evapotranspiration local characteristic curve and/or other factors, as herein presented.

Two refining factors, a watering depth factor W and a compensation coefficient S may be used to further refine the optimal watering budget.

The watering depth factor W provides a reduction in water delivery, reflecting a reduced watering requirement due to the increased watering depth provided when utilizing the FROG 10. As promoted by the local water authorities, the FROG 10 delivers a proportionally larger volume of water that is applied at less frequent intervals. Consequently, the water penetrates the soil more deeply, less surface evaporation occurs, and more water is left in the soil for the plant to access. Additionally, the less frequent, deeper watering of the FROG 10 encourages deeper root growth in plants, resulting in healthier plants.

The compensation coefficient S is used to further refine the novel algorithm of the present invention. The compensation coefficient S is a factor correcting for lack of daily watering frequency due to mandated no-watering restriction days, the corresponding plant seasonal moisture needs, and an assumed soil type characteristic for locale (affecting the water delivery rate [percolation] calculations)

Referring to FIG. 11, the novel algorithm used by the FROG 10, includes the following variables:

D_{x/wk}=Initial number of Days per week that Zoneₓ valve is open (91, FIG. 11)

E_{x/day}=Initial number of watering Events per day for Zoneₓ valve (92, FIG. 11)

Mo_{x/event}=Minutes of initial run-time duration (initial minutes per watering event for Zoneₓ from existing controller settings) (93, FIG. 11)

Mo_{x/wk}=initial watering Minutes of water per week for Zoneₓ (from existing controller settings) (96, FIG. 11)

Ms_{x/event}=Scaled watering Minutes (run-time duration) of water per event for Zoneₓ (96, FIG. 11)

D_{A/wk}=number of Days Allowed per week in mandated watering restriction (94, FIG. 11)

ET_{local}=value for Dayₙ from ET local characteristic curve (95, FIG. 11)

ETₐᵥₑ=average of the ET_{local} values of the days since last watering (98, FIG. 11)

W=Watering Depth factor allowing reduction of the total volume of water due to the reduction in water need due to the increased depth of watering resulting from a larger volume of water applied at larger intervals

S=Compensation coefficient, a factor correcting for lack of daily watering frequency due to mandated no-watering restriction days, the corresponding plant seasonal moisture needs, and an assumed soil type characteristic for locale (affecting the water delivery rate [percolation] calculations)

As seen in FIG. 11, the variables D_{x/wk}, E_{x/day}, and Mo_{x/event} are determined from the learn mode. The D_{A/wk} and ET_{local} are pre-programmed into the FROG 10. And Mo_{x/wk} and Ms_{x/event} are calculated in the following equation:

Mo_{x/wk}=(D_{x/wk})*(E_{x/day})*(Mo_{x/event})

For example (for a single zone x, summer maximum set at existing controller):

5 min/event*3 events/day*7 days/week=105 minutes/week

The Ms_{x/wk} derived from UN-AVERAGED ET_{local} (using the ET_{local} of the particular date) is derived from the following equation:

{Mo_{x/wk}/[D_{A/wk}*E_{x/day}]}*{ET_{local}}*S*W=Ms_{x/wk}

A somewhat more refined Ms_{x/wk} may be obtained by averaging multiple ET_{local} values (averaging the ET_{local} values of the days since last watering or another set of ET_{local} values from nearby days)

First ETₐᵥₑ is calculated by averaging the ET_{local} values corresponding to the days since the last watering; then ETₐᵥₑ is substituted in the above equation resulting in the following equation:

{Mo_{x/wk}/[D_{A/wk}*E_{x/day}]}*{ETₐᵥₑ}*S*W =Ms_{x/wk}

So, in the above example, 105 minutes/week divided by 3 days per week (allowed by watering restrictions) times 3 events per day (the number of watering events per day programmed in the existing controller)=11.66 minutes/event multiplied by the Compensation coefficient S and the Watering Depth Factor W and the scale factor ET_{local} (in the un-averaged equation) or ETₐᵥₑ (in the averaged equation).

Many modifications may be made to the above equations to provide further benefits or to achieve conservation goals. For example, though the example variables are based on a time period of a week, other time periods are equally usable, such as a two week period. Or, for another example, the algorithm can be simplified, such as by omitting the S coefficient or the W factor.

Also, optionally, instead of using E_{x/day} to determine Ms_{x/wk}, (where E_{x/day} represents the number of watering events per day for Zoneₓ of the summer watering schedule), it may be desirable to use a reduced number of watering events per day (for instance in winter when watering is minimized). Thus a winter algorithm might use E_{W/day} (where E_{W/day} represents the number of watering events per day for Zoneₓpreferred in the winter season).

{Mo_{x/wk}/[D_{A/wk}*E_{W/day}]}*{ETₐᵥₑ}*S*W =Ms_{x/wk}

Another modification may be made to the above equations to account for the voluntary no-watering day discussed below. If the voluntary no-watering day is enabled, the D_{A/wk} (the number of days allowed per week as defined in the mandated watering restriction) would be reduced by 1 (the one voluntary no-watering day) unless that would result in zero watering days. Therefore, the minimum for D_{A/wk} is one day, as the minimum number of watering days a week is one day.

The usefulness and/or novelty of the algorithm combines with the usefulness and/or novelty of the integration of the mandated no-watering days and the empirically-derived evapotranspiration local characteristic curve, with the possibility of further integrating the voluntary no-watering day, and in the availability of the presented variables, factors, and coefficients for manipulation to derive a FROG watering schedule that achieves the goals of adequate water delivery for the landscape and of water conservation.

Once the foregoing process is complete, the microcontroller program awaits the next start time, whereupon the process may be repeated, and so on and so forth until the entire irrigation cycle is complete. When the entire irrigation cycle is complete, the entire process repeats at the next scheduled irrigation cycle, and may continue to do so until an error occurs or user intervention stops the cycle. There is no inherent need for the user to reprogram or interact with the FROG at the onset of a new season as previously required for conventional irrigation controllers.

In an embodiment, the FROG may have an “override mode” permitting the user to operate his existing controller manually as though there were no FROG in series between the existing controller 20 and the irrigation valves 30. Preferably, the FROG is configured with basic input device 17 to activate override mode, along with an audible or visual indicator 65, such as a flashing LED, to signal that override mode is running. For aesthetics, the input device 17 and indicator 65 preferably match in appearance and location the other basic input devices 15, 16, 18, 19 and indicators 66, 67 of learn mode and run mode. When the user has activated override mode, the microcontroller program performs all functions as usual, except that instead of causing “on” and “off” commands to be communicated to the relays 27 operating the irrigation valves 30, it simply causes the “on” and “off” commands of the existing controller 20 to be communicated to the relays 27 operating the irrigation valves 30.

When the FROG is in the four-week learn mode, during the first two weeks the microcontroller program operates the FROG as though it were in override mode for purposes of irrigation. However, operation in override mode is not indicated by the override mode indicator and, unlike override mode, the FROG 10 surveys the wired zones, etc., as provided above.

The second embodiment, shown in FIG. 2, of the FROG 10 is a “comprehensive controller,” which also utilizes the novel integration and/or novel algorithm of the present invention, but additionally is configured with all the functionality of a conventional irrigation controller, allowing a user to program start times and run-time durations for the various zones. There is no longer a need for the existing controller 20 or another conventional controller.

Conventional rotary dials 57, switches, and digital input devices allow the user to manually program the FROG 10 comprehensive controller. The comprehensive controller may be housed in an open housing 48 (FIG. 4) or in a housing with a door 58 (FIG. 2). A conduit 59 may be connected to the housing to allow the field wires to be routed to the outside water control valves 30.

The third embodiment of FIG. 3, FIG. 4, and FIG. 9 also utilizes the novel integration and/or novel algorithm of the present invention, but further includes a sensor module 60 connectable to either the add-on FROG (FIG. 3) or the comprehensive FROG (FIG. 4). The sensor module 60 is in communication with a remote weather station 55 (FIG. 3, FIG. 4, FIG. 9). Preferably, the remote sensors 41, 42 are configured to communicate wirelessly with the main control unit 24, which is configured to receive and process the received remote sensor data.

Remote weather station 55 includes one or more environmental sensors 41, 42 (FIG. 9) to measure environmental conditions, such as temperature, humidity, solar radiation, soil moisture, rainfall, or the like.

The addition of one or more environment sensors 41, 42 to provide current environmental data may, in some cases, provide a beneficial refinement to the novel integration and/or novel algorithm of the present invention. Additionally, some municipalities mandate the usage of one or more sensors with any installed automatic irrigation controller (such as a mandated rain gauge). Thus the FROG 10 of the third embodiment is adapted to meet that requirement.

The remote, freestanding weather station 55 is preferably mounted in an exterior location where accurate environmental readings can be obtained. Preferably the sensor data is wirelessly transmitted by a transmission device, such as RF transmitter 43 (with antenna 38), to obviate the need for wiring. Therefore, the weather station 55 is preferably situated in a suitable location to allow wireless communication through walls made of ordinary construction materials. The FROG 10 controller is configured with a corresponding RF receiver 39 (FIG. 8).

Optionally, the sensors 41, 42, as well as the RF transmitter 43, may be powered by a solar-powered system, comprising a solar energy conversion panel 45, solar charger 47, and a charge storage system 46. Use of such a solar-powered system eliminates the expense, maintenance and disposal of batteries, plus avoids the inevitable disruption caused by undetected battery failure.

In one exemplary aspect, the sensors 41, 42 output their readings to modulation device 44 that is set to turn on the RF transmitter 43 and relay readings at a predetermined sample rate, such as once per hour, continuously day and night. The sample rate is sufficient to provide accurate overall environmental values, expressed as an arithmetic average, over the entire time period from one irrigation cycle to the next, but not so frequent as to unnecessarily draw down system resources and interfere with the similar systems operating at adjacent properties.

To use the sensor data, the sensor data are preferably averaged and the values stored in EEPROM 26. On watering days, the microcontroller program retrieves the current group of environmental sensor readings in EEPROM 26 for the specific time period of interest, preferably, since the last scheduled start time for the zone in question. The microcontroller program uses an environmental-factor calculation algorithm to output a current temperature value and current humidity value. The environmental-factor calculation algorithm preferably calculates the arithmetic average of readings from the time a given irrigation cycle was last scheduled to the time it is next scheduled to derive a “current environmental factor.” Other similar environmental-factor calculation algorithms (such as ones that cast out outliers or average only the last two days) are also within the scope of the invention.

The current environmental factor E, may be used as an additional scaling factor in the novel algorithm, as follows:

{M_{ox/wk}/[D_{A/wk}*E_{x/day}]}*{ET_{local}}*S*W*E=M_{sx/wk}

The fourth embodiment (FIG. 5A, FIG. 5B, FIG. 5C, FIG. 5D, FIG. 6A, FIG. 6B, FIG. 6C, FIG. 7A, FIG. 7B, FIG. 7C) presents an optional supplementary user input system 70 for use with either the add-on or comprehensive FROG, either with or without the connectable sensor module 50 and remote weather station. The supplementary user input system 70 allows a user (or water authority representative) to conveniently input information into the FROG 10, thus the FROG 10 can be updated periodically, either frequently or infrequently, as needed.

In a first aspect, FIG. 5A, FIG. 5B, FIG. 5C, FIG. 5D, the supplementary user input system 70 includes a reader slot 71 configured to receive an insertable sheet 68 imprinted with an optical code 69 and includes an optical code reader 72.

The optical code 69 may be a printed QR Code®, bar code, matrix code, or other two-dimensional code for carrying data. The optical code 69 may contain any of a variety of water restriction information or irrigation controller instructional information; this information is individually customizable for the particular home (or business). For example, optical code 69 may be used to specify the mandated watering restrictions, to specify the assigned watering group, to specify the geographic location, to change the start times, or the like. Moreover, the optical code 69 allows the water authority to implement changes to data preloaded into the FROG 10, the necessity of which may become greater as the years pass. For instance, if weather and climate patterns change (such as through changes in the La Nina and El Nino patterns, global warming, or the like), the preloaded empirically-derived evapotranspiration local characteristic curve may become less reliable. It is easy to update the FROG 10 using the optical code 69 (or other disclosed supplementary user input system 70); thus the FROG 10 will continue to perform within a reasonable range of conservation expectations, with the parameter values at or near current climatic conditions.

The optical code 69 is printed on the insertable sheet 68 in an appropriate location to position the optical code 69 for reading when the insertable sheet 68 is inserted into the reader slot 71.

The optical code reader 72 captures the visual information from the optical code 69 and converts it into a corresponding digital code usable by the microcontroller.

The availability of a simple means to allow the user to input data may be of great advantage to both the user and to the water authority. For instance, the local water authority can (at virtually no cost) routinely print an optical code 69 carrying the mandated watering restrictions, geographic location, the assigned watering group, and/or an updated empirically-derived evapotranspiration local characteristic curve for the home associated with the bill. If the FROG 10 experiences a power outage without the backup battery power, one or more settings may be lost or corrupted (including the preloaded mandated watering restrictions and/or geographic location and/or assigned watering group). The homeowner merely inserts the bill with the optical code 69 into the reader slot 71 and the optical reader 72 converts the optical data to re-establish the mandated watering restrictions and/or geographic location and/or assigned watering group and/or other settings. Instructions on how to insert the bill so that the optical code 69 is readable can also be printed on the bill. As no interaction is required with the local water authority employees, this method of re-establishing data is very cost effective for the water authority, as well as being convenient for the homeowner.

Additionally, if the homeowner receives digital bills instead of paper bills, the homeowner can log onto his account at the water authority and print the optical code 69 customized for his home, which is then inserted into reader slot 71.

Further, easy instructions can be presented by using the optical code 69. For example, if the real time clock needs to be reset, the homeowner can log onto his account online and print an optical code 69, which, when inserted into reader slot 71, causes easy, step-by-step instructions for resetting the clock to be displayed on the graphic display 60.

An insertable sheet 68 carrying optical code 69 could optionally be included with a new FROG 10, to initially establish some variables.

In a second aspect of the fourth embodiment, FIG. 6A, FIG. 6B, FIG. 6C, the supplementary user input system 70 includes a slide track or slide slot 73 configured to receive a data-carrying card 77 (such as a plastic card with an embedded magnetic code using magnetic stripe technology or a smartcard having an embedded microprocessor with stored data or the like) and includes a magnetic code/smartcard reader 74. The FROG 10 is configured with the slide track 73, the magnetic code/smartcard reader 74, and corresponding circuitry.

The card 77 carrying data 78 may be similar to a credit card in size. Data-carrying card 77 can be supplied to the homeowner upon request or might optionally be included with a new FROG 10. The magnetic code/smartcard reader 74 is adapted for reading the carried data 78.

In a similar manner as in the first aspect, the carried data 78 can contain any data or information needed by the homeowner, such as mandated watering restrictions, geographic location, assigned watering group, etc.

In a third aspect of the fourth embodiment, FIG. 7A, FIG. 7B, FIG. 7C, the supplementary user input system 70 the FROG 10 is configured with an electronic connection 75 configured to receive a complementary electronic connector 61. The electronic connection 75 may be an industry standard connection (such as a USB, a typical input/output relay circuit bank, or a low voltage DC interface connected to the AC/DC opto-coupler input sensing circuits 14) allowing communication to be established between an external device and the FROG 10. For example, a computer having scheduling and/or irrigation software could interface with the FROG 10 to facilitate remote control and/or dynamic scheduling capabilities. Or, as illustrated, a data storage unit 79, such as a flash drive, can be configured with complementary electronic connector 61. The microcontroller is configured to read the digitally stored data.

The supplementary user input system 70 of the third aspect functions similarly to the supplementary user input systems 70 of the first and second aspects and can contain data for establishing data, re-establishing data, or instructional information. Additionally, sufficient data can be conveyed to the FROG 10 to update the microcontroller program.

In another aspect of the FROG smart controller of the present invention, the ability for the homeowner to choose to designate one additional day as a user-donated “float” day (a voluntary no-watering day) is enabled. Preferably the user not only specifies that he wishes to relinquish one allowed watering day, but also may be allowed to choose the particular day of the week to be relinquished. This is generally done in exchange for a credit from the local water authority on the homeowner's water bill. Thus an advantage is provided to both the local water authority (reduction in water usage) and to the homeowner (reduction in water bill).

One problem occurs if the float day is enableable by the user via an input button or switch on the device—the local water authority cannot be assured that the remotely located FROG 10 in the individual houses has remained enabled. The user could remove the float day activation, yet still receive the bill credit. To prevent this problem, the FROG 10 is preferably sold in two species, a float-day-enabled FROG 10 and a no-float FROG 10. Preferably the float-day-enabled FROG 10 is configured with a user-option toggle operable to manually or digitally allow the user to change the day of the week of the float day, but not to remove the enabled float day.

Removal of the float day (if, for example, the homeowner later changes his mind) could be implemented by sending a water authority service person to manually change the setting (such as by using a USB data storage unit 79 to update the microcontroller program by connecting to the electronic connection 75). Alternatively, the homeowner could remove the float day by requesting a supplementary user input system 70 configured to direct the microcontroller program to remove the float day. For example, the homeowner could receive an insertable sheet 68 with an optical code 69, a card 77 imprinted with a magnetic code 78, or a USB data storage unit 79 from the water authority that carried the information necessary to instruct the microcontroller program to remove the float day. The homeowner would then insert the supplementary user input system 70 into his FROG 10 and he would no longer receive a water credit. If, after requesting and receiving the supplementary user input system 70 carrying the float day removal instructions to the microcontroller, the homeowner fails to insert the supplementary user input system 70 into the corresponding slot of his FROG 10, he would continue to donate the float day, but would not continue to receive the water credit.

From the foregoing, it will be apparent that the FROG 10 smart controller solves the problem of delivering adequate water for landscaping needs by utilizing the empirically-derived evapotranspiration local characteristic curve and preloaded local mandatory and voluntary watering restrictions, while incorporating a water need increase affected by the reduced number of mandated and voluntary no-watering days and a water need reduction affected by deeper, less frequent watering.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalents.

I claim:

1. An add-on irrigation controller for controlling water control valves for utilizing with an existing controller set with initial start times and initial run-time durations, comprising:
a housing,
a microcontroller housed within said housing and programmed with a microcontroller program operative to receive and transmit data and to control the operation of said add-on irrigation controller; wherein said add-on irrigation controller is capable of determining said initial start times and said initial run-time durations from said existing controller; wherein said add-on irrigation controller is preloaded with an evapotranspiration local characteristic curve for at least one locality and with local mandatory watering restrictions for said at least one locality; wherein said evapotranspiration local characteristic curve and said local mandatory local mandatory watering restrictions are accessible to said microcontroller program; and wherein said microcontroller program is configured to calculate a FROG watering schedule based on at least said evapotranspiration local characteristic curve, on said local mandatory watering restrictions, on said initial start times, and on said initial run-time durations; and wherein said microcontroller program is capable of utilizing said FROG watering schedule to control said water control valves.
at least one non-volatile memory configured to receive and to store data from said microcontroller; and
a real-time clock operatively connected to said microcontroller.

2. The add-on irrigation controller, as recited in claim 1, wherein said add-on irrigation controller is pre-programmed with a voluntary no-watering day enabled and said microcontroller program further bases said FROG watering schedule on said voluntary no-watering day.

3. The add-on irrigation controller, as recited in claim 1, further comprising at least one basic input device configured to allow designation of an assigned watering group.

4. The add-on irrigation controller, as recited in claim 1, wherein said FROG watering schedule is further based on the total water volume as delivered by said existing controller over a particular number of days near the day of watering, as determined from said initial start times and said initial run-time durations, proportioned to the number of allowed watering days near the day of watering as defined by said local mandatory watering restrictions

5. The add-on irrigation controller, as recited in claim 1, further comprising:
a freestanding remote weather station comprising at least one environmental sensor operable to obtain and to output sensor data, wherein said freestanding remote weather station is configured to transmit said sensor data;
a sensor module configured to receive said sensor data and operable to transmit said sensor data to said add-on irrigation controller, wherein said microcontroller program further bases said FROG watering schedule on said sensor data.

6. The add-on irrigation controller, as recited in claim 1, further comprising a supplementary user input system configured to allow data to be imported into said add-on irrigation controller.

7. The add-on irrigation controller, as recited in claim 6 wherein said data imported from said supplementary user input system comprises an updated evapotranspiration local characteristic curve.

8. The add-on irrigation controller, as recited in claim 6, wherein said supplementary user input system comprises an optical reader operable to read an inserted optical code.

9. An irrigation controller for regulating water control valves corresponding to watering zones, comprising:
a microcontroller programmed with a microcontroller program for controlling the operation of said water control valves and configured to receive and transmit data;
at least one non-volatile memory configured to receive and to store data from said microcontroller, wherein said at least one non-volatile memory is preloaded with at least one evapotranspiration local characteristic curve for at least one locality and with local mandatory watering restrictions for said at least one locality, and wherein said microcontroller program bases controlling the operation of said water control valves at least partially on said at least one evapotranspiration local characteristic curve for at least one locality and said local mandatory watering restrictions for said at least one locality; and
a real-time clock operatively connected to said microcontroller.

10. The irrigation controller, as recited in claim 9, wherein said irrigation controller is pre-programmed with the activation of a voluntary no-watering day and said microcontroller program further bases controlling the operation of said water control valves on said voluntary no-watering day.

11. The irrigation controller, as recited in claim 9, further comprising at least one basic input device configured to allow designation of an assigned watering group.

12. The irrigation controller, as recited in claim 9, further comprising a supplementary user input system configured to allow data to be imported into said add-on irrigation controller.

13. The irrigation controller, as recited in claim 9, further comprising at least one input device configured to allow a user to input start times and run-time durations for said multiple watering zones.

14. A method for an add-on irrigation controller to control water control valves, comprising:
preloading said add-on irrigation controller with at least one evapotranspiration local characteristic curve for at least one locality and with local mandatory watering restrictions for said at least one locality and with a microcontroller program configured to derive a FROG watering schedule;
wiring said add-on irrigation controller in series between said water control valves and an existing controller set with initial start times and initial run-time durations;
initiating learn mode in the add-on irrigation controller;
learning, by said microcontroller program, said initial start times and said initial run-time durations;
deriving, by said microcontroller program, said FROG watering schedule based on at least said initial start times and said initial run-time durations and on the integration of said at least one evapotranspiration local characteristic curve with said local mandatory watering restrictions.

15. The method for an add-on irrigation controller to control water control valves, as recited in claim 14, wherein said add-on irrigation controller is additionally preloaded with an enabled voluntary no-watering day, and wherein said deriving, by said microcontroller program, said FROG watering schedule is further based on integration of said enabled voluntary no-watering day.

16. The method for an add-on irrigation controller to control water control valves, as recited in claim 14, wherein said FROG watering schedule is further based on the total water volume as delivered by said existing controller over a particular number of days near the day of watering, as determined from said initial start times and said initial run-time durations, proportioned to the number of allowed watering days near the day of watering as defined by said local mandatory watering restrictions.

17. The method for an add-on irrigation controller to control water control valves, as recited in claim 14, further comprising inputting data into said add-on irrigation controller through a supplementary user input system.

18. The method for an add-on irrigation controller to control water control valves, as recited in claim 14, further comprising receiving sensor date from at least one remote sensor, wherein said FROG watering schedule is further based on said sensor data.

19. The method for an add-on irrigation controller to control water control valves, as recited in claim 14, wherein said learning, by said microcontroller program, said initial start times and said initial run-time durations comprises:
initiating in said add-on irrigation controller, a first two-week period of learning-override mode wherein said add-on irrigation controller learns said initial start times and said initial run-time durations, but does not control said water control valves;
allowing, for the first two-week period, said existing controller to continue to control said water control valves based on set said initial start times and said initial run-time durations;
resetting, at the end of said first two-week period, said initial start times and said initial run-time durations in said existing controller to a summer maximum watering schedule including summer maximum start times and summer maximum run-time durations;
controlling, by said add-on irrigation controller starting at the end of said first two-week period and continuing for a second two-week period, said water control valves to duplicate said initial start times and said initial run-time durations learned;
initiating, in said add-on irrigation controller starting at the end of said first two-week period and continuing through said second two-week period, a learning-controlling mode wherein said add-on irrigation controller learns said summer maximum start times and said summer maximum run-time durations; and
controlling, by said add-on irrigation controller starting at the end of said second two-week period, said water control valves by applying said FROG watering schedule to control said water control valves.

20. The method for an add-on irrigation controller to control water control valves, as recited in claim 14, wherein said FROG watering schedule is further based on the total water volume delivered by said existing controller over a particular number of days near the day of watering, as determined from said initial start times and said initial run-time durations, proportioned to the number of allowed watering days near the day of watering as defined by said local mandatory watering restrictions.
